(19) United States
(12) Patent Application Publication
(10) Pub. No.: US 2026/0349194 A1
(43) Pub. Date: Nov. 5, 2026

(54) OPTICAL APPARATUS WITH A LOW LOSS SURFACE-COUPLED INTERFACE

(71) Applicant: Cisco Technology, Inc., San Jose, CA (US)

(72) Inventors: Euijae SHIM, Oceanside, CA (US); Marc P. SAVANIER, Del Mar, CA (US); Roman BRUCK, Pressbaum (AT); Attila MEKIS, Carlsbad, CA (US)

(21) Appl. No.: 19/195,593

(22) Filed: Apr. 30, 2025

(51) Int. Cl. G02B 6/42; G02B 6/293

(52) U.S. Cl. CPC G02B 6/4215; G02B 6/29311; G02B 6/2938

(57) ABSTRACT

Optical apparatuses are provided. In one aspect, an apparatus includes a demultiplexer arranged to separate wavelength signals from an optical signal. The wavelength signals have different wavelengths. The apparatus also includes a photonic chip having grating couplers each arranged to receive one of the wavelength signals separated from the optical signal. Each one of the grating couplers has a grating focal plane arranged to match a signal focal plane of one of the wavelength signals separated from the optical signal and output by the demultiplexer.

### TECHNICAL FIELD

Embodiments presented in this disclosure generally relate to optical apparatuses having a demultiplexing device and a photonic chip.

### BACKGROUND

Optical multiplexing/demultiplexing devices are used in optical communication systems to combine or separate multiple optical signals of different wavelengths. This process is important to the efficient use of optical fibers in telecommunications, data center interconnects, and other applications that involve high-bandwidth data transmission. In some optical communication systems, demultiplexed signals of different wavelengths can be directed to respective grating couplers of a photonic chip. Coupling losses at the grating couplers interface should ideally be matched to balance the optical powers across the communication channels. This has presented certain challenges, as the coupling loss penalty between the best and worst channels can be greater than 0.5 dB.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 is a schematic block diagram illustrating an apparatus in accordance with aspects of the present disclosure.

FIG. 2 is a close-up view of the apparatus of FIG. 1.

FIG. 3 is a top view of one of the grating couplers of a photonic chip of the apparatus of FIG. 1.

FIG. 4 is a schematic view depicting signal focal planes of individual wavelength signals matching respective grating focal planes of the grating couplers.

FIG. 5 is a close-up schematic view of the apparatus of FIG. 1 and depicts an alternative manner in which the grating focal planes of the grating couplers can be matched.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

In one aspect, an apparatus is disclosed. The apparatus includes a demultiplexer arranged to separate wavelength signals from an optical signal. The wavelength signals have different wavelengths. The apparatus also includes a photonic chip having grating couplers each arranged to receive one of the wavelength signals separated from the optical signal. Each one of the grating couplers has a grating focal plane arranged to match a signal focal plane of one of the wavelength signals output by the demultiplexer.

In another aspect, an apparatus is disclosed. The apparatus includes a demultiplexer arranged to separate wavelength signals from an optical signal, the wavelength signals having different wavelengths. The apparatus also includes a photonic chip having grating couplers each arranged to receive one of the wavelength signals separated from the optical signal. The grating couplers are chirped with successively increasing or decreasing chirp rates from one grating coupler to a next grating coupler so that grating focal planes of the grating couplers each match a signal focal plane of one of the wavelength signals output by the demultiplexer at different heights with respect to a top surface of the photonic chip.

In yet another aspect, an apparatus is disclosed. The apparatus includes a demultiplexer arranged to separate wavelength signals from an optical signal, the wavelength signals having different wavelengths. The apparatus also includes an output lens array having output lenses each having a same curvature and arranged along an output lens plane, wherein the wavelength signals pass through respective ones of the output lenses after being output by the demultiplexer. Further, the apparatus includes a photonic chip having grating couplers each arranged along a grating coupler plane that is parallel to the output lens plane, wherein each of the grating couplers are operable to receive one of the wavelength signals focused thereon by the output lenses. Each one of the grating couplers outputs a grating coupler beam that has a grating focal plane arranged to match a signal focal plane of one of the wavelength signals output by the demultiplexer.

### EXAMPLE EMBODIMENTS

Disclosed herein are apparatuses, e.g., optical transceivers, that include features for facilitating low optical loss at a surface-coupled optical interface between a demultiplexer and a photonic chip. In at least one aspect, an apparatus can include a demultiplexer arranged to separate wavelength signals from an optical signal. The wavelength signals can have different wavelengths or bands. The apparatus can further include a photonic chip and an output lens array having output lenses that focus respective ones of the separated wavelength signals to respective grating couplers of the photonic chip. The grating couplers are each arranged to receive one of the separated wavelength signals, and thus, the grating couplers can provide a surface-coupled optical interface between the demultiplexer and the photonic chip. Each one of the grating couplers can have a grating focal plane arranged to match a signal focal plane of one of the separated wavelength signals traveling to the grating couplers. The grates of the grating couplers can be “chirped” so that the grating focal plane of the grating coupler beams output by the grating couplers match the signal focal planes. For instance, the periodicity between adjacent grates and/or the grating linewidths of the gratings can be strategically configured to achieve a target grating focal plane. The matching of the grating focal planes with their respective signal focal planes can facilitate low optical losses at the grating couplers, which can improve system efficiency and performance.

The disclosed apparatuses can provide one or more advantages, benefits, and/or technical effects. For instance, by strategically configuring the grates of the grating couplers so that their grating focal planes match the signal focal planes of the wavelength signals output from the demultiplexer, efficient optical coupling can be achieved at the grating couplers with optical loss penalties across channels being minimized, such as being less than 0.2 dB between the best and worst cases. Further, the disclosed apparatuses can enable the output lenses of the output lens array to be formed identically and with the same curvature (i.e., so that they each have a same focal distance). Accordingly, customization of the output lens array can be eliminated or reduced. Further, adapting the angle of the demultiplexer on the photonics chip, e.g., by way of shim or custom angled component, can be eliminated or reduced. This can reduce the mechanical constraints within the apparatus package. Other advantages, benefits, and/or technical effects are contemplated.

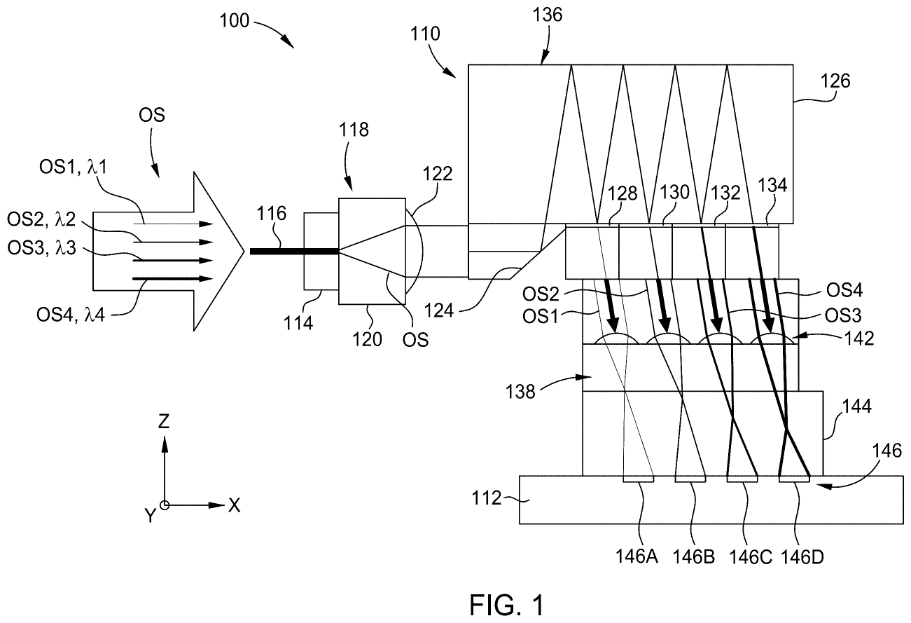

Turning now to the drawings, FIG. 1 is a schematic block diagram illustrating an apparatus 100 according to one or more aspects of the present disclosure. In at least one example, the apparatus 100 can be an optical transceiver. For reference, the apparatus 100 defines an X-direction, a Y-direction, and a Z-direction, which are mutually perpendicular to one another. In one or more examples, the X-direction can be a longitudinal direction, the Y-direction can be a lateral direction, and the Z-direction can be a vertical direction.

For the depicted example of FIG. 1, the apparatus 100 includes a demultiplexer 110, a photonic chip 112, and a fiber array 114. The demultiplexer 110 can be disposed on the photonic chip 112, either directly or indirectly. In at least one example, the demultiplexer 110 can be a multiplexer/demultiplexer (MDM), such as a multi-channel Coarse Wavelength Division Multiplexing (CWDM) device. The photonic chip 112 can include a substrate, cladding, and photonic components, e.g., forming a photonic integrated circuit (PIC). The fiber array 114 is coupled with the demultiplexer 110 and can include at least one optical fiber 116. An optical signal OS can be provided to the demultiplexer 110 by way of the optical fiber 116. The optical signal OS can be a multi-wavelength optical signal, or rather, a multiplexed optical signal. For instance, as shown schematically in FIG. 1, the optical signal OS can carry multiple wavelength signals each having a different wavelength. In the example of FIG. 1, the optical signal OS includes a first wavelength signal OS1 having a first wavelength λ1, a second wavelength signal OS2 having a second wavelength λ2, a third wavelength signal OS3 having a third wavelength λ3, and a fourth wavelength signal OS4 having a fourth wavelength λ4, with the first, second, third, and fourth wavelengths λ1, λ2, λ3, λ4 being different from one another.

The demultiplexer 110 is arranged to split the combined optical signal OS into its individual components. In this regard, the demultiplexer 110 can act as a demultiplexer arranged to separate the optical signal OS into a plurality of individual wavelength signals having different wavelengths. More particularly, the demultiplexer 110 is arranged to separate the first wavelength signal OS1, the second wavelength signal OS2, the third wavelength signal OS3, and the fourth wavelength signal OS4 from the optical signal OS into individual, spatially-separated signals. While operation of the demultiplexer 110 will be described herein with respect to separating a multi-wavelength optical signal (i.e., in a demultiplexing operation), it will be appreciated that, in at least one example, the demultiplexer 110 may also be used as a multiplexer to combine individual signals into a combined optical signal (i.e., in a multiplexing operation).

As shown in FIG. 1, the apparatus 100 has an input lens array 118 (or output lens array from the multiplexing perspective). The input lens array 118 has an input block 120 and at least one input lens 122. The optical fiber 116 is aligned with the input lens 122 for facilitating optical coupling of the optical fiber 116 with the input lens 122. The optical signal OS provided to the demultiplexer 110 can expand in width while traveling through the input block 120 and then can be collimated by the input lens 122. The collimated optical signal OS can be directed to a prism 124 of the demultiplexer 110. The prism 124 can change the propagation direction of the collimated optical signal OS, e.g., from a generally horizontal direction to a generally vertical direction, or stated differently, from the X-direction to the Z-direction. The propagation direction of the optical signal OS can be changed so that the optical signal OS is provided to an optical block 126 of the demultiplexer 110. The optical block 126 can also be referred to as a “Z-block”.

Further, the demultiplexer 110 can include multiple filters. In the illustrated example of FIG. 1, the demultiplexer 110 includes a first filter 128, a second filter 130, a third filter 132, and a fourth filter 134. In other examples, the demultiplexer 110 can include more or less than four (4) filters. The filters can be thin film filters (TFFs), for example. Each of the filters 128, 130, 132, 134 can be associated with a wavelength (or range of wavelengths) of the optical signal OS input into the demultiplexer 110.

For instance, the optical signal OS directed into the optical block 126 by the prism 124 can be reflected from a surface 136 of the optical block 126 towards the first filter 128. The first filter 128 can allow the first wavelength signal OS1 to separate from the optical signal OS and propagate to the photonic chip 112. The first wavelength signal OS1 can have the first wavelength λ1. The first filter 128 can reflect the optical signal OS (i.e., the remaining portions thereof) back to the optical block 126.

The optical signal OS can once again be reflected from the surface 136 of the optical block 126, but this time, the optical signal OS is reflected towards the second filter 130. The second filter 130 can allow the second wavelength signal OS2 to separate from the optical signal OS and propagate to the photonic chip 112. The second wavelength signal OS2 can have the second wavelength λ2. The second wavelength λ2 can be different than the first wavelength λ1 of the first wavelength signal OS1. The second filter 130 can reflect the optical signal OS (i.e., the remaining portions thereof) back to the optical block 126.

The optical signal OS can yet again be reflected from the surface 136 of the optical block 126, and in this instance, the optical signal OS is reflected towards the third filter 132. The third filter 132 can allow the third wavelength signal OS3 to separate from the optical signal OS and propagate to the photonic chip 112. The third wavelength signal OS3 can have the third wavelength λ3. The third wavelength can be different than the first and second wavelengths λ1, λ2 of the first wavelength signal OS1 and the second wavelength signal OS2, respectively. The third filter 132 can reflect the optical signal OS (i.e., the remaining portions thereof) back to the optical block 126.

The optical signal OS can be reflected from the surface 136 of the optical block 126 a final time, and in this case, the optical signal OS is reflected towards the fourth filter 134. The fourth filter 134 can allow the fourth wavelength signal OS4 to separate from the optical signal OS and propagate to the photonic chip 112. The fourth wavelength signal OS4 can have the fourth wavelength λ4. The fourth wavelength λ4 can be different than the first, second, and third wavelengths λ1, λ2, λ3 of the first wavelength signal OS1, the second wavelength signal OS2, and the third wavelength signal OS3, respectively. The fourth filter 134 can reflect noise and/or signals of other wavelengths back to the optical block 126, where such signals can dissipate.

Accordingly, the demultiplexer 110 can be arranged to separate the optical signal OS into individual first, second, third, and fourth wavelength signals OS1, OS2, OS3, OS4 each having different wavelengths.

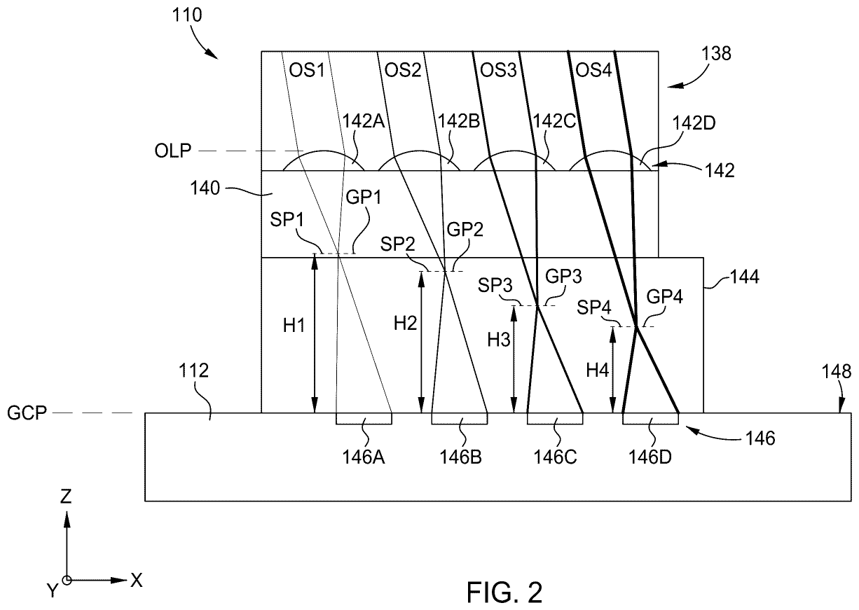

The apparatus 100 can also include an output lens array 138 (or input lens array from the multiplexing perspective). The output lens array 138 has an output block 140 and a plurality of output lenses 142 through which respective ones of the plurality of individual wavelength signals OS1, OS2, OS3, OS4 travel through on their way to the photonic chip 112. The plurality of output lenses 142 include a first output lens 142A, a second output lens 142B, a third output lens 142C, and a fourth output lens 142D (see FIG. 2). The first wavelength signal OS1 travels through the first output lens 142A and to the photonic chip 112, the second wavelength signal OS2 travels through the second output lens 142B and to the photonic chip 112, the third wavelength signal OS3 travels through the third output lens 142C and to the photonic chip 112, and the fourth wavelength signal OS4 travels through the fourth output lens 142D and to the photonic chip 112. Thus, the output lenses 142 focus their respective individual wavelength signals OS1, OS2, OS3, OS4 toward the photonic chip 112. In at least one example, the plurality of output lenses 142 are identical in design and/or each have a same curvature or radius of curvature. In at least one example, the output lenses 142 are arranged along an output lens plane OLP (FIG. 2). The apex of curvature of each one of the output lenses 142 can be arranged along the output lens plane OLP. The output lens plane OLP can be perpendicular to the Z-direction.

As further shown in FIG. 1, the wavelength signals OS1, OS2, OS3, OS4 travel through the demultiplexer 110 different distances. The first wavelength signal OS1 travels a shortest distance through the demultiplexer 110. The first wavelength signal OS1 is carried by the optical signal OS through the input lens 122 and to the optical block 126, where the optical signal OS reflects from the surface 136 a single time before the first wavelength signal OS1 passes through the first filter 128 and onward to the first output lens 142A. The second wavelength signal OS2 travels a longer distance through the demultiplexer 110 than the first wavelength signal OS1. The second wavelength signal OS2 is carried by the optical signal OS through the input lens 122 and to the optical block 126, where the optical signal OS reflects from the surface 136 two times before the second wavelength signal OS2 passes through the second filter 130 and onward to the second output lens 142B. The third wavelength signal OS3 travels a longer distance through the demultiplexer 110 than the second wavelength signal OS2. The third wavelength signal OS3 is carried by the optical signal OS through the input lens 122 and to the optical block 126, where the optical signal OS reflects from the surface 136 three times before the third wavelength signal OS3 passes through the third filter 132 and onward to the third output lens 142C. The fourth wavelength signal OS4 travels a longer distance through the demultiplexer 110 than the third wavelength signal OS3. The fourth wavelength signal OS4 is carried by the optical signal OS through the input lens 122 and to the optical block 126, where the optical signal OS reflects from the surface 136 four times before the fourth wavelength signal OS4 passes through the fourth filter 134 and onward to the fourth output lens 142D.

In at least one example, the apparatus 100 can include a spacer 144 arranged between the output lens array 138 and the photonic chip 112. The spacer 144 can be formed of glass, for example. In other examples, the space between the output lens array 138 and the photonic chip 112 can be air or a free-space void.

The photonic chip 112 has a plurality of grating couplers 146 with each grating coupler being arranged to receive one of the plurality of individual wavelength signals OS1, OS2, OS3, OS4. For the depicted example of FIG. 1, the photonic chip 112 includes a first grating coupler 146A, a second grating coupler 146B, a third grating coupler 146C, and a fourth grating coupler 146D arranged to receive the first, second, third, and fourth individual wavelength signals OS1, OS2, OS3, OS4, respectively. The first, second, third, and fourth grating couplers 146A, 146B, 146C, 146D can be optically coupled with respective waveguides of the photonic chip 112. In at least one example, the grating couplers 146 are arranged along a grating coupler plane GCP. The grating coupler plane GCP can be arranged parallel to the output lens plane OLP, e.g., as shown in FIG. 2. The grating coupler plane GCP can be perpendicular to the Z-direction.

FIG. 2 shows a close-up view of the individual wavelength signals OS1, OS2, OS3, OS4 exiting the demultiplexer 110 and being received by their respective grating couplers 146A, 146B, 146C, 146D. As shown in FIG. 2, the individual wavelength signals OS1, OS2, OS3, OS4 traveling toward the photonic chip 112 have different signal focal planes, and they are not coplanar with the top surface 148 of the photonic chip 112. Rather, the signal focal planes of the individual wavelength signals OS1, OS2, OS3, OS4 are arranged at different heights with respect to the top surface 148 of the photonic chip 112. In this example, the first wavelength signal OS1 has a first signal focal plane SP1 arranged at a first height H1 with respect to the top surface 148 of the photonic chip 112. The second wavelength signal OS2 has a second signal focal plane SP2 arranged at a second height H2 with respect to the top surface 148 of the photonic chip 112. The third wavelength signal OS3 has a third signal focal plane SP3 arranged at a third height H3 with respect to the top surface 148 of the photonic chip 112. Finally, the fourth wavelength signal OS4 has a fourth signal focal plane SP4 arranged at a fourth height H4 with respect to the top surface 148 of the photonic chip 112. The second height H2 is less than the first height H1, the third height H3 is less than the second height H1, and the fourth height H4 is less than the third height H3.

In one or more examples, the output lenses 142 can each be identical in design and can have the same curvature. Moreover, in such examples, the first, second, third, and fourth wavelength signals can travel between the input lens 122 and their respective output lenses 142 different distances, as described above. Consequently, the individual wavelength signals OS1, OS2, OS3, OS4 traveling toward the photonic chip 112 can have different signal focal planes SP1, SP2, SP3, SP4. Coupling losses at the grating couplers 146 can occur if left unaddressed. The outer channels (the first wavelength signal OS1 and fourth wavelength signal OS4) can be particularly susceptible to coupling loss penalties.

In one or more examples, the coupling loss can be lowered by arranging the grating couplers 146 to match the focal planes of the individual wavelength signals as they exit the demultiplexer 110. Each of the grating couplers 146 can be arranged to focus at the height that corresponds to the location of the image plane of the demultiplexer beam of the particular wavelength band. Accordingly, in one or more examples, each one of the grating couplers 146 has a grating focal plane arranged to match a signal focal plane of one of the individual wavelength signals traveling from the demultiplexer 110 to the plurality of grating couplers 146.

As illustrated in FIG. 2, the first grating coupler 146A has a first grating focal plane GP1 that matches the first signal focal plane SP1 of the first wavelength signal OS1. That is, the first signal focal plane SP1 and the first grating focal plane GP1 are arranged at the first height H1 with respect to the top surface 148 of the photonic chip 112.

Similarly, the second grating coupler 146B has a second grating focal plane GP2 that matches the second signal focal plane SP2 of the second wavelength signal OS2. As depicted, both the second signal focal plane SP2 and the second grating focal plane GP2 are arranged at the second height H2 with respect to the top surface 148 of the photonic chip 112.

Likewise, the third grating coupler 146C has a third grating focal plane GP3 that matches the third signal focal plane SP3 of the third wavelength signal OS3. Stated another way, both the third signal focal plane SP3 and the third grating focal plane GP3 are arranged at the third height H3 with respect to the top surface 148 of the photonic chip 112.

Also, the fourth grating coupler 146D has a fourth grating focal plane GP4 that matches the fourth signal focal plane SP4 of the fourth wavelength signal OS4. Stated differently, both the fourth signal focal plane SP4 and the fourth grating focal plane GP4 are arranged at the fourth height H4 with respect to the top surface 148 of the photonic chip 112. As noted previously, the second height H2 is less than the first height H1, the third height H3 is less than the second height H1, and the fourth height H4 is less than the third height H3.

By matching the grating focal planes GP1, GP2, GP3, GP4 of the grating couplers 146 with the signal focal planes SP1, SP2, SP3, SP4 of their respective individual wavelength signals OS1, OS2, OS3, OS4, coupling losses at the grating couplers 146 can be reduced. In at least one example, the variation of optical coupling loss between each of the grating couplers 146 is less than 0.2 dB.

In one or more examples, the grating focal planes GP1, GP2, GP3, GP4 of the grating couplers 146 can be arranged to match with the signal focal planes SP1, SP2, SP3, SP4 of the individual wavelength signals OS1, OS2, OS3, OS4 by chirping the grates of the grating couplers 146.

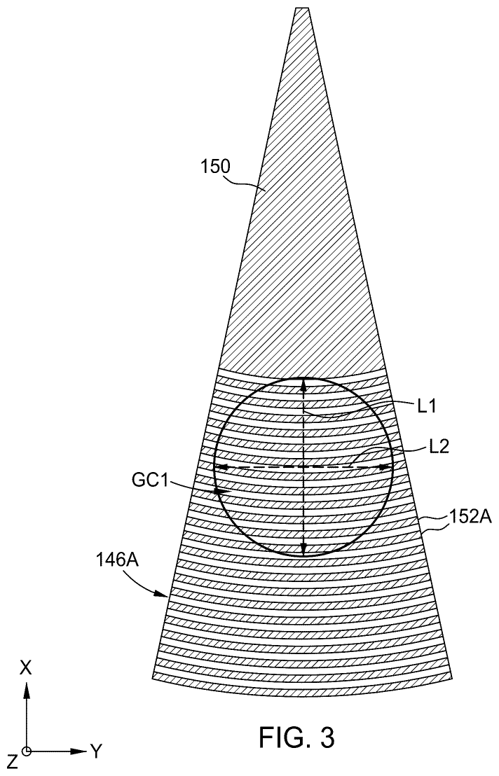

FIG. 3 depicts a top view of the first grating coupler 146A optically coupled with a waveguide 150. The other grating couplers 146 can be configured in a similar manner as the first grating coupler 146A. As shown, the first grating coupler 146A includes a plurality of grates 152A spaced from one another along the X-direction. The first grating coupler 146A can output a first grating beam GC1, which is focused at the first grating focal point GP1 (FIG. 2). The first grating beam GC1 has a longitudinal dimension L1, which is the length of the first grating beam GC1 along the X-direction in this example. The longitudinal dimension L1 of the first grating beam GC1 is dependent on the chirp rate of the grates 152A. The first grating beam GC1 also has a lateral dimension L2, which is the length of the first grating beam GC1 along the Y-direction in this example.

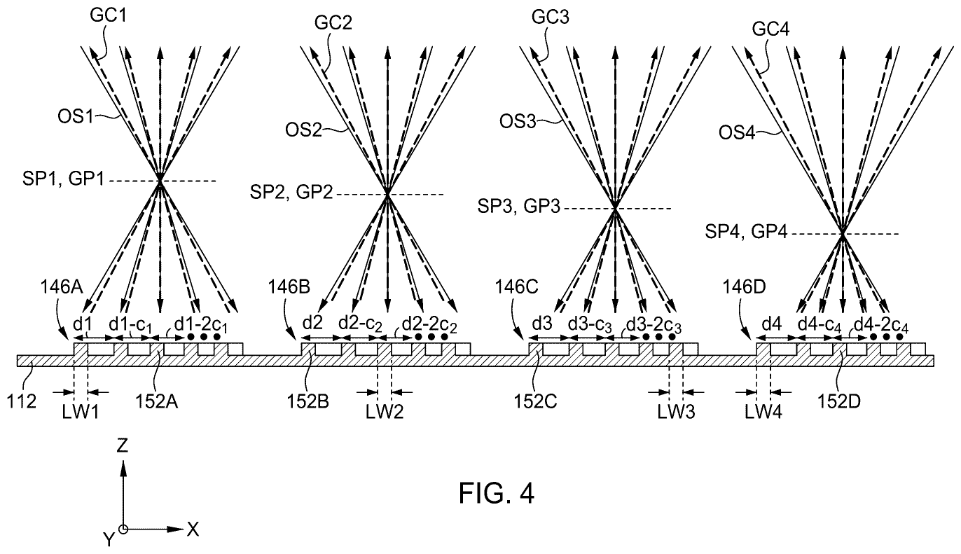

The focal plane height of a grating coupler beam output by a given grating coupler, such as the first grating coupler beam GC1 output by the first grating coupler 146A, can be targeted by chirping the duty cycle and/or the period of the given grating coupler. In at least one example, the chirp rate can be defined as the rate of change in periodicity between adjacent grates of a given grating coupler. In at least one example, the chirp rate can be defined as the rate of change in grate linewidth. In at least one example, the chirp rate can be defined as the rate of change in periodicity between adjacent grates of a given grating coupler and the rate of change in grate linewidth. Generally, the higher the chirp rate, the lower the height of the target focal plane of the grating coupler beam. Moreover, in at least one example, the higher the chirp rate, the smaller the mode (both for trench, as light is extracted faster along X-direction, and pitch, as waist gets closer to chip surface, see e.g., FIG. 4). Further, in at least one example, the grating coupler beam can be focused laterally, in the transverse direction Y, by adding a fourth-order component to the elliptical grating shape.

FIG. 4 depicts a schematic view of the grating focal planes GP1, GP2, GP3, GP4 of the grating couplers 146 (or rather of the outputted first, second, third, and fourth grating coupler beams GC1, GC2, GC3, GC4) matching the signal focal planes SP1, SP2, SP3, SP4 of the individual wavelength signals OS1, OS2, OS3, OS4, and also depicts an example manner in which the grates of the grating couplers 146 can be chirped.

As shown in FIG. 4, the grating couplers 146 can be chirped along the X-direction. In the example of FIG. 4, the grates 152A of the first grating coupler 146A have a first chirp rate c₁, which corresponds to a rate of change in periodicity between adjacent grates of the grates 152A. A first one of the grates 152A is spaced from a second one of the grates 152A by a distance d1 along the X-direction. The second one of the grates 152A is spaced from a third one of the grates 152A by a distance d1-c₁ along the X-direction, or rather, a difference determined by subtracting the first chirp rate c₁ from the distance d1. The third one of the grates 152A is spaced from a fourth one of the grates 152A by a distance d1-2c₁ along the X-direction, or rather, a difference determined by subtracting a product of the first chirp rate c₁ and two (2) from the distance d1. Other ones of the grates 152A can be chirped in a similar manner.

Similarly, the grates 152B of the second grating coupler 146B have a second chirp rate c₂, which corresponds to a rate of change in periodicity between adjacent grates of the grates 152B. A first one of the grates 152B is spaced from a second one of the grates 152B by a distance d2 along the X-direction. The second one of the grates 152B is spaced from a third one of the grates 152B by a distance d2-c₂ along the X-direction, or rather, a difference determined by subtracting the second chirp rate c₂ from the distance d2. The third one of the grates 152B is spaced from a fourth one of the grates 152B by a distance d2-2c₂ along the X-direction, or rather, a difference determined by subtracting a product of the second chirp rate c₂ and two (2) from the distance d2. The second chirp rate c₂ can be different than the first chirp rate c₁. Other ones of the grates 152B can be chirped in a similar manner.

Likewise, the grates 152C of the third grating coupler 146C have a third chirp rate c₃, which corresponds to a rate of change in periodicity between adjacent grates of the grates 152C. A first one of the grates 152C is spaced from a second one of the grates 152C by a distance d3 along the X-direction. The second one of the grates 152C is spaced from a third one of the grates 152C by a distance d3-c₃ along the X-direction, or rather, a difference determined by subtracting the third chirp rate c₃ from the distance d3. The third one of the grates 152C is spaced from a fourth one of the grates 152C by a distance d3-2c₃ along the X-direction, or rather, a difference determined by subtracting a product of the third chirp rate c₃ and two (2) from the distance d3. The third chirp rate c₃ can be different than both the first chirp rate c₁ and the second chirp rate c₂. Other ones of the grates 152C can be chirped in a similar manner.

Finally, the grates 152D of the fourth grating coupler 146D have a fourth chirp rate c₄, which corresponds to a rate of change in periodicity between adjacent grates of the grates 152D. A first one of the grates 152D is spaced from a second one of the grates 152D by a distance d4 along the X-direction. The second one of the grates 152D is spaced from a third one of the grates 152D by a distance d4-c₄ along the X-direction, or rather, a difference determined by subtracting the fourth chirp rate c₄ from the distance d4. The third one of the grates 152D is spaced from a fourth one of the grates 152D by a distance d4-2c₄ along the X-direction, or rather, a difference determined by subtracting a product of the fourth chirp rate c₄ and two (2) from the distance d4. The fourth chirp rate c₄ can be different than the first chirp rate c₁, the second chirp rate c₂, and the third chirp rate c₃. Other ones of the grates 152D can be chirped in a similar manner.

In at least one example, the second chirp rate c₂ is higher than the first chirp rate c₁, the third chirp rate c₃ is higher than the second chirp rate c₂, and the fourth chirp rate c₄ is higher than the third chirp rate c₃. In this regard, the chirp rates of the grating couplers 146 can successively increase from one grating coupler to the next, which effectively focuses the grating focal planes of the grating couplers 146 at different heights with respect to the top surface 148 of the photonic chip 112, e.g., as shown in FIGS. 2 and 4.

In at least one example, the grating coupler that receives the wavelength signal having the longest distance traveled through the demultiplexer has a highest chirp rate of any of the grating couplers and the grating coupler that receives the wavelength signal having the shortest distance traveled through the demultiplexer has a lowest chirp rate of any of the grating couplers. For instance, the fourth grating coupler 146D receives the fourth wavelength signal OS4, which travels the longest distance through the demultiplexer 110 compared to the other wavelength signals OS1, OS2, OS3, as noted above. Accordingly, the fourth grating coupler 146D can have the highest chirp rate, which can provide a lowest focal plane height and smallest longitudinal grating coupler beam size. Further, the first grating coupler 146A receives the first wavelength signal OS1, which travels the shortest distance through the demultiplexer 110 compared to the other wavelength signals OS2, OS3, OS4, as noted above. Accordingly, the first grating coupler 146A can have the lowest chirp rate, which can provide a highest focal plane height and largest longitudinal grating coupler beam size. Also, in such examples, the third grating coupler 146C can have the second highest chirp rate, which can provide a second lowest focal plane height and a second smallest longitudinal grating coupler beam size. The second grating coupler 146B can have the third highest chirp rate, which can provide a third lowest focal plane height and a third smallest longitudinal grating coupler beam size. Accordingly, the chirp rates of the grating couplers can be correlated with the distances the wavelength signals travel through the demultiplexer 110.

As noted above, the gratings of one or more of the grating couplers 146 can be chirped in grate linewidth in addition or alternatively to chirping the periodicity between adjacent grates of a given grating coupler. In at least one example, with reference to FIG. 4, the grate linewidths of the grates 152A (the grate linewidth LW1 of one of the grates 152A is denoted in FIG. 4) can increase or decrease from one grate to the next by a first chirp rate, e.g., by a factor of two (2), by a factor of one half (½), by a factor of one third (⅓), etc. For instance, the grate linewidth of a second one of the grates 152A can be double the grate linewidth of a first one of the grates 152A, the grate linewidth of a third one of the grates 152A can be double the grate linewidth of the second one of the grates 152A, the grate linewidth of a fourth one of the grates 152A can be double the grate linewidth of the third one of the grates 152A, and so on.

Similarly, a grate linewidth of the grates 152B (the grate linewidth LW2 of one of the grates 152B is denoted in FIG. 4) can increase or decrease from one grate to the next by a second chirp rate, which is different than the first chirp rate. Likewise, a grate linewidth of the grates 152C (the grate linewidth LW3 of one of the grates 152C is denoted in FIG. 4) can increase or decrease from one grate to the next by a third chirp rate, which is different than the first chirp rate and the second chirp rate. Finally, a grate linewidth of the grates 152D (the grate linewidth LW4 of one of the grates 152D is denoted in FIG. 4) can increase or decrease from one grate to the next by a fourth chirp rate, which is different than the first chirp rate, the second chirp rate, and the third chirp rate. In at least one example, the chirp rates of the grating couplers 146 can successively increase or decrease from one grating coupler to the next.

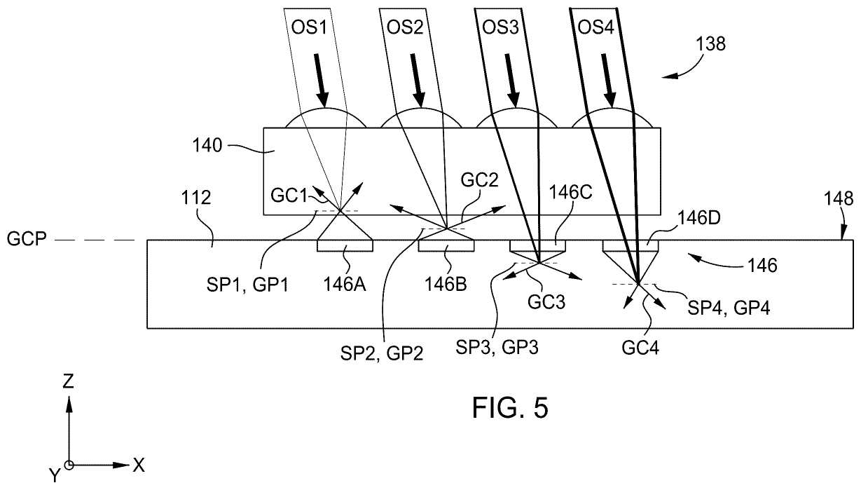

FIG. 5 is a close-up schematic view of the apparatus 100 of FIG. 1 and depicts an alternative manner in which the grating focal planes GP1, GP2, GP3, GP4 of the grating couplers 146 can be focused. Indeed, in FIG. 5, the signal focal planes SP1, SP2, SP3, SP4 of the individual wavelength signals OS1, OS2, OS3, OS4 are depicted matching their respective grating focal planes GP1, GP2, GP3, GP4 of the grating couplers 146, with at least one of the grating focal planes being focused below a grating coupler plane.

As shown in FIG. 5, the first grating coupler 146A is arranged (e.g., chirped) so that the first grating focal plane GP1 matches the first signal focal plane SP1 above a grating coupler plane CGP, which is coplanar with the top surface 148 of the photonic chip 112 in this example. The first grating coupler beam GC1 output by the first grating coupler 146A is focused above the grating coupler plane CGP, e.g., to a position within the output block 140 of the output lens array 138. The second grating coupler 146B is arranged (e.g., chirped) so that the second grating focal plane GP2 matches the second signal focal plane SP2 above or at the grating coupler plane CGP. The second grating coupler beam GC2 output by the second grating coupler 146B is focused above or at the grating coupler plane CGP. In at least one example, the first grating coupler 146A and the second grating coupler 146B can each have a positive chirp, e.g., so as to focus their respective first grating focal plane GP1 and second grating focal plane GP2 above or at the grating coupler plane GCP along the Z-direction.

In the depicted example of FIG. 5, the third grating coupler 146C is arranged (e.g., chirped) so that the third grating focal plane GP3 matches the third signal focal plane SP3 below the grating coupler plane CGP, e.g., along the Z-direction. The third grating coupler beam GC3 output by the third grating coupler 146C is focused below the grating coupler plane CGP, e.g., to a position within the photonic chip 112. Likewise, the fourth grating coupler 146D is arranged (e.g., chirped) so that the fourth grating focal plane GP4 matches the fourth signal focal plane SP4 below the grating coupler plane CGP, e.g., along the Z-direction. The fourth grating coupler beam GC4 output by the fourth grating coupler 146D is focused below the grating coupler plane CGP, e.g., to a position within the photonic chip 112 and below the third grating focal plane GP3. In at least one example, the third grating coupler 146C and the fourth grating coupler 146D can each have a negative chirp, e.g., so as to focus their respective third grating focal plane GP3 and fourth grating focal plane GP4 below the grating coupler plane GCP along the Z-direction.

In at least one example, the grating couplers are arranged so that their grating focal planes match their respective signal focal planes of the individual wavelength signals above or at the grating coupler plane. In at least one example, the grating couplers are arranged so that their grating focal planes match their respective signal focal planes of the individual wavelength signals below or at the grating coupler plane. In at least one example, the grating couplers are arranged so that the grating focal plane of at least one of the grating couplers matches a signal focal plane of one of the individual wavelength signals above or at the grating coupler plane and so that the grating focal plane of at least one of the grating couplers matches a signal focal plane of one of the individual wavelength signals below the grating coupler plane, e.g., as shown in FIG. 5.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s).

In view of the foregoing, the scope of the present disclosure is determined by the claims that follow.

We claim:

1. An apparatus, comprising:
a demultiplexer arranged to separate wavelength signals from an optical signal, the wavelength signals having different wavelengths; and
a photonic chip having grating couplers each arranged to receive one of the wavelength signals separated from the optical signal,
wherein each one of the grating couplers has a grating focal plane arranged to match a signal focal plane of one of the wavelength signals output by the demultiplexer.

2. The apparatus of claim 1, wherein the grating focal planes are each arranged at different heights with respect to a top surface of the photonic chip.

3. The apparatus of claim 1, wherein the grating couplers each have different chirp rates, wherein a chirp rate is defined as a rate of change in periodicity between adjacent grates of a given one of the grating couplers.

4. The apparatus of claim 3, wherein the chirp rates of the grating couplers successively increase or decrease from one grating coupler to a next grating coupler.

5. The apparatus of claim 1, wherein the grating couplers each have different chirp rates, wherein a chirp rate is defined as a rate of change in grate linewidth of grates of a given one of the grating couplers.

6. The apparatus of claim 1, wherein the demultiplexer has an output lens array having output lenses through which respective ones of the wavelength signals travel through, and wherein the grating couplers are in optical communication with the output lens array.

7. The apparatus of claim 6, wherein the output lenses each have a same curvature.

8. The apparatus of claim 1, wherein an optical coupling loss variation between each one of the grating couplers is less than 0.2 dB.

9. The apparatus of claim 1, wherein the wavelength signals include a first wavelength signal, a second wavelength signal, a third wavelength signal, and a fourth wavelength signal, which each have a different wavelengths and travel different distances through the demultiplexer, and
wherein the grating couplers include a first grating coupler, a second grating coupler, a third grating coupler, and a fourth grating coupler arranged to receive the first, second, third, and fourth wavelength signals, respectively.

10. The apparatus of claim 9, wherein:
wherein the first wavelength signal travels a shortest distance through the demultiplexer, the second wavelength signal travels a longer distance through the demultiplexer than the first wavelength signal, the third wavelength signal travels a longer distance through the demultiplexer than the second wavelength signal, and the fourth wavelength signal travels a longer distance through the demultiplexer than the third wavelength signal, and
wherein the first grating coupler has a first chirp rate, the second grating coupler has a second chirp rate that is higher than the first chirp rate, the third grating coupler has a third chirp rate that is higher than the second chirp rate, and the fourth grating coupler has a fourth chirp rate that is higher than the third chirp rate.

11. The apparatus of claim 10, wherein:
the grating focal plane of the first grating coupler matches the signal focal plane of the first wavelength signal at a first height with respect to a top surface of the photonic chip,
the grating focal plane of the second grating coupler matches the signal focal plane of the second wavelength signal at a second height with respect to the top surface of the photonic chip, with the second height being less than the first height,
the grating focal plane of the third grating coupler matches the signal focal plane of the third wavelength signal at a third height with respect to the top surface of the photonic chip, with the third height being less than the second height, and
the grating focal plane of the fourth grating coupler matches the signal focal plane of the fourth wavelength signal at a fourth height with respect to the top surface of the photonic chip, with the fourth height being less than the third height.

12. The apparatus of claim 1, wherein the grating couplers are arranged so that the grating focal plane of at least one of the grating couplers matches a signal focal plane of one of the wavelength signals above a top surface of the photonic chip.

13. The apparatus of claim 1, wherein the grating couplers are arranged so that the grating focal plane of at least one of the grating couplers matches a signal focal plane of one of the wavelength signals below a top surface of the photonic chip.

14. The apparatus of claim 1, wherein the grating couplers are arranged so that the grating focal plane of at least one of the grating couplers matches a signal focal plane of one of the wavelength signals above a top surface of the photonic chip and so that the grating focal plane of at least one of the grating couplers matches a signal focal plane of one of the wavelength signals below the top surface of the photonic chip.

15. An apparatus, comprising:
a demultiplexer arranged to separate wavelength signals from an optical signal, the wavelength signals having different wavelengths; and
a photonic chip having grating couplers each arranged to receive one of the wavelength signals separated from the optical signal,
wherein the grating couplers are chirped with successively increasing or decreasing chirp rates from one grating coupler to a next grating coupler so that grating focal planes of the grating couplers each match a signal focal plane of one of the wavelength signals output by the demultiplexer at different heights with respect to a top surface of the photonic chip.

16. The apparatus of claim 15, wherein the chirp rate for a given one of the grating couplers is defined as a rate of change in periodicity between adjacent grates of the given one of the grating couplers or as a rate of change in grate linewidth of grates of the given one of the grating couplers, or both.

17. The apparatus of claim 15, wherein the demultiplexer has an output lens array having output lenses through which respective ones of the wavelength signals travel through, and wherein the grating couplers are in optical communication with the output lens array, and wherein the output lenses each have a same curvature.

18. The apparatus of claim 15, wherein a grating coupler of the grating couplers that receives the wavelength signal having a longest distance traveled through the demultiplexer has a highest chirp rate of any of the grating couplers and a grating coupler of the grating couplers that receives the wavelength signal having a shortest distance traveled through the demultiplexer has a lowest chirp rate of any of the grating couplers.

19. The apparatus of claim 15, wherein the apparatus is an optical transceiver.

20. An apparatus, comprising:
a demultiplexer arranged to separate wavelength signals from an optical signal, the wavelength signals having different wavelengths;
an output lens array having output lenses each having a same curvature and arranged along an output lens plane, wherein the wavelength signals pass through respective ones of the output lenses after being output by the demultiplexer; and
a photonic chip having grating couplers each arranged along a grating coupler plane that is parallel to the output lens plane, wherein each of the grating couplers are operable to receive one of the wavelength signals focused thereon by the output lenses,
wherein each one of the grating couplers outputs a grating coupler beam that has a grating focal plane arranged to match a signal focal plane of one of the wavelength signals output by the demultiplexer.
